(19) United States
(12) Patent Application Publication
(10) Pub. No.: US 2003/0076817 A1
(43) Pub. Date: Apr. 24, 2003

(54) Apparatus and method for interfacing internet telephone

(76) Inventor: Myoung-tak Han, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/182,827

(22) PCT Filed: Feb. 2, 2001
(86) PCT No.: PCT/KR01/00150

(30) Foreign Application Priority Data
Feb. 3, 2000 (KR) 2000/5507
Jan. 11, 2001 (KR) 2001/1545

(51) Int. Cl. H04L 12/56

(52) U.S. Cl. 370/352; 370/401

(57) ABSTRACT

An apparatus and a method for an Internet telephone interface are provided. According to a method for making an Internet phone call using an IP address, a database of the IP address of a plurality of terminal connected to the Internet is made and when a first terminal requests the IP address of a second terminal the database is searched for the IP address of the second terminal and the IP address of the second terminal is provided to the first terminal so that the first terminal can make an Internet phone call to the second terminal. According to the apparatus and method, when an Internet phone call is made, an audio output signal, which is received by an external terminal connected to an external ordinary telephone, is output to the handset of the external ordinary telephone, and an audio input signal, which is received by the external ordinary telephone, is input to an audio input signal processing unit of the external terminal so that an Internet phone call is connected using the external ordinary telephone. By doing so, making an Internet phone call using an external ordinary telephone is enabled.

### TECHNICAL FIELD

The present invention relates to an apparatus and method for an Internet telephone interface, and more particularly, to an interface apparatus with which one ordinary telephone can be used for both a station line telephone call and an Internet call, and a method making an Internet phone call between Internet providers (IP) using an IP relay server.

### BACKGROUND ART

Thanks to recent developments in computers and communications, various applications using multimedia or multimedia information processing are being introduced. The Internet that connects almost all places of the world is becoming more commonly used, and recently, is used for a long-distance call and an international call. A service for a call through the Internet enables to establish a call connection not through the existing telephone network but through the Internet. That is, a personal computer (PC) having Internet phone software, a speaker, a microphone, a sound card, and a universal serial bus (USB) connector, is connected to the Internet and then connected to another user 3 s PC having the same system so as to make a phone call as a station line telephone. Since Vocaltec of Israel introduced an Internet phone in February, 1995, the use of the Internet phone has been rapidly spread all over the world, from a PC-to-PC connection at the initial stage, to a PC-to-telephone connection, and now to a telephone-to-telephone connection.

Despite the Internet phone's problems of lower sound quality than a station line telephone connection, and inconvenience of a called person, who has to be in an online wait state, the Internet phone enables to make an international call at cheaper price and to digitally send multimedia data, including both pictures and documents, because the call is connected through the Internet. Therefore, the popularity of the Internet phone is rapidly increasing.

FIG. 1 shows the-structure of the system for a conventional Internet call.

Referring to FIG. 1,. Internet service providers (ISP) 118 and 120 provide basic services for the PC 102 of user A 100 and the PC 130 of user B 128 to be connected to the Internet 116. Examples of ISPs are Korea Telecom and Hanaro Telecom. Internet telephone providers 122 and 124 are service providers who provide telephone call services. Examples of Internet telephone providers are Dial Pad or Wow Call. The Internet telephone providers provide services for establishing a call connection between personal computers which are connected to the Internet telephone providers, and also provide services for establishing a call connection through a telephone network between a PC connected to the Internet telephone providers and the telephone of the called.

An Internet telephony gateway 126 converts Internet protocol packet data, which is transmitted by the Internet telephone provider servers 122 and 124, into data having a format used in a telephone network 112 and transmits the converted data to an exchange 114. Also, the Internet telephony gateway 126 converts data, which is transmitted by the exchange 114, into Internet protocol packet data and transmits the converted data to the Internet telephone provider servers 122 and 124.

Referring to FIG. 1, methods for making a phone call between user A 100 and user B 128 will now be explained. Routes L1 through L3 show methods for making a phone call. In route 1 L1, a call is connected between telephones 108 and 136 through exchanges 110 and 114, and a telephone network 112. In route 2 L2, computers 102 and 130 having microphones 104 and 132 and speakers 106 and 134 access ISP servers 118 and 120 on the Internet 116 and then, a call is connected between the PC 102 and the telephone 136 through Internet telephone provider servers 122 and 124. In route 3 L3, a call is connected between the PC 102 and PC 130 through Internet telephone provider servers 122 and 124, or a call is connected directly between the PC 102 and PC 130 connected to the Internet 116, using an IP address without passing through the Internet telephone provider servers 122 and 124.

Among the methods, the operation methods of the routes 2 and 3 L2 and L3 will now be explained in more detail.

First, in the PC-to-PC Internet phone call between the PC 102 and PC 130, both two users, who desire a telephone conversation, access the Internet 116, then access the Internet phone server of an Internet telephone provider, and establishes a call connection between the two users. The PC program of a speaking person digitizes an analog voice signal which is input through the microphone 104, compresses the digitized voice signal, makes the signal into packets using a protocol, such as H323, a resource reservation protocol (RSVP), or a real-time protocol/real-time control protocol (RTP/RTCP), and transmits the voice signal in units of a packet through the Internet 116 to the PC 130 of a listening person. Then, the receiving side PC 130 decompresses packets, converts digitized packet data into an analog voice signal, and the original voice is restored through the speaker 134.

Next, in the Internet phone call between the PC 102 and the telephone 136, which corresponds to route 2 L2, needed programs are installed. The PC 102 accesses the Internet 116, a ring signal is transmitted through the telephone network 112 and the Internet phone gateway 126 to the telephone 136, and a call is connected. Though the caller uses the PC 102 as in the PC-to-PC Internet phone call between the PC 102 and PC 130, this method is an advanced method because the called person talk using the station line telephone 136. That is, the PC-to-PC Internet phone call is based only on the Internet, while in the PC-to-telephone Internet phone call the caller is based on the Internet and the called person uses an Existing telephone call. The role of the Internet phone gateway 126 is to connect the Internet 116 and the existing telephone network 112.

However, in the conventional Internet phone call services implemented by the PC-to-PC Internet phone call or the PC-to-telephone Internet phone call, the users have to use speakers 106 and 134 and microphones 104 and 132 connected to sound cards, and they have to sit close to the PC 102 and 130, talk to the microphones 104 and 132, and listen to the speakers 106 and 134. Inconveniently, each user has to wear a headphone having a microphone 104 for stably hearing a voice. Also, when the caller desires to make an Internet phone call using an IP address, the caller has to know the called person's IP address in advance. That is, the caller has to confirm each IP address of called persons, and if a called person uses a variable IP address, it is difficult for the caller to make a phone call to the called person because the IP address of the called person changes whenever the caller accesses the ISP.

### DISCLOSURE OF THE INVENTION

To solve the above problems, it is an object of the present invention to provide an Internet telephone interface apparatus, with which both a station line telephone call connection and an Internet phone call can be connected using an ordinary external telephone, and a method thereof.

It is another object to provide an Internet telephone interface apparatus, with which, when a caller makes a phone call using an IP address, the caller receives the IP address of a person desired to be called, from an IP relay server so that the caller can easily make a phone call the person desired to be called, and a method thereof.

To accomplish the above object of the present invention, there is provided an apparatus for an Internet telephone interface, in which an Internet phone call is made using an external ordinary telephone, the apparatus having an Internet call processing unit for transmitting an audio output signal, which is received by an external terminal, to the handset of the external ordinary telephone, and for providing an audio input signal, which is received by the external ordinary telephone, to an audio input signal processing unit of the external terminal; a station line telephone call processing unit for detecting an off-the-hook state of the external ordinary telephone and detecting an incoming station line telephone call; a dual tone multi-frequency (DTMF) transmitter and receiver for detecting a DTMF tone of a dial key of the external ordinary telephone and transmitting the DTMF tone to the station line telephone call processing unit; a first switching unit for selectively connecting the external ordinary telephone to one of the station line telephone and the Internet, a second switching unit for selectively switching the signal, which is output from the audio output signal processing unit of the external terminal and sent to a signal processing unit for processing an audio input signal from the outside, to an audio signal output unit to an external connection apparatus; a third switching unit for selectively switching the signal, which is input to the audio input signal processing unit of the external terminal and sent to a signal processing unit for processing an audio output signal to the outside, to one of the Internet call processing unit and an audio signal input unit of the external connection apparatus; a control unit for controlling the first switching unit in a station line telephone mode so that the external ordinary telephone is connected to a station line telephone, and controlling the first switching unit, the second switching unit, and the third switching unit in an Internet call mode so that the external ordinary telephone is connected to the Internet call processing unit, the audio signal output processing unit of the external terminal is connected to the receiver of the external telephone through the Internet call processing unit, and the audio signal input processing unit of the external terminal is connected to the transmitter of the external telephone through the Internet call processing unit; and an input/output (I/0) interface unit for receiving and transmitting data between the external terminal and the telephone interface apparatus.

It is preferable that Internet call processing unit has a subscriber line interface circuit for connecting the external connection apparatus and the external ordinary telephone with a subscriber line; a unit for generating a ring sound in the external ordinary telephone when the Internet call incomes; a unit for generating an alarm sound to indicate an incoming station line telephone call during an Internet phone call, by generating an alarm sound in the external ordinary telephone; an off-the-hook detecting unit for detecting an off-the-hook state of the external ordinary telephone; and a unit for generating a dial tone in the external ordinary telephone when the external ordinary telephone is off the hook.

It is preferable that the station line telephone processing unit has a unit for detecting an incoming station line telephone call; a unit for generating an alarm sound in the external ordinary telephone when an Internet phone call incomes during a station line telephone call; and a unit for detecting the off-the-hook state of the external ordinary telephone.

It is preferable that the switching units are implemented by relay devices or switching devices.

It is preferable that the external terminal is a personal computer.

To accomplish another object of the present invention, there is also provided an apparatus for an Internet telephone interface in an Internet protocol (IP) relay server system for making an Internet phone call using an IP address, the apparatus having a plurality of personal computers (PCs), each of which has an assigned IP address; an Internet Service Provider (ISP) for connecting the plurality of PCS to the Internet; and an IP relay server for storing an IP address, which is assigned to the PC of a member registered in the IP server system connected to the Internet, together with the name, identification (ID), connection number, and ordinary telephone number, for each member, and, when a first member requests the IP address of a second member, searching a database for the IP address of the PC, which the second member is using, and providing the IP address to the first member.

It is preferable that the IP address of each PC is a variable IP address of a fixed IP address.

To accomplish another object of the present invention, there is also provided a method for making an Internet phone call using an external ordinary telephone by using an apparatus for an Internet telephone interface, the method having the steps of outputting an audio output signal, which is received by an external terminal connected to an external ordinary telephone, to the handset of the external ordinary telephone when an Internet phone call is connected; and inputting an audio input signal, which is received by the external ordinary telephone, to an audio input signal processing unit of the external terminal so that an Internet phone call is connected using the external ordinary telephone.

To accomplish another object of the present invention, there is also provided a method for making an Internet phone call using an external ordinary telephone by using IP addresses, the method having the steps of making a database of the IP address of a plurality of terminals connected to the Internet; and searching the database for the IP address of a second terminal, when a first terminal requests the IP address of the second terminal, and providing the IP address to the first terminal so that the first terminal can make an Internet phone call to the second terminal.

To accomplish another object of the present invention, there is also provided a method for setting an initial environment of an Internet telephone interface apparatus in a method for making an Internet phone call using an external ordinary telephone, the method for setting an initial environment having the steps of starting an external terminal connected to the Internet telephone interface apparatus; obtaining an IP address after accessing an Internet service provider's server through the external terminal; and setting an initial environment of an application program of the Internet telephone interface apparatus implemented in the external terminal.

It is preferable that the method further has the steps of setting a basic connection route of the external ordinary telephone; setting a mutual conversion code for changing the set connection route of the external ordinary telephone; and setting a connection number, an ID, a password, a serial communications port, a mutual conversion code, and setting default states for ‘cancel/stop’ button, ‘Internet phone call termination/initiation’ button, ‘connect telephone to computer’ button,. ‘connect telephone to ordinary telephone line’ button, ‘turn on external speaker’ button, ‘turn off external speaker’ button, and ‘flash’ button.

To accomplish another object of the present invention, there is also provided a method for an Internet telephone interface, for making an Internet phone call in an apparatus for an Internet telephone interface, using an external ordinary telephone, the method for an Internet telephone interface having the steps of checking the basic connection route of the external ordinary telephone; setting a call connection route to a person to be called through the Internet if the basic connection route is set to a transmission route for an Internet phone call mode; transmitting an audio output signal, which is received by an external terminal connected to the external ordinary telephone, to the handset of the external ordinary telephone; and transmitting an audio input signal, which is received by the external ordinary telephone, to an audio input terminal of the external terminal.

It is preferable that the method further has the step for making a phone call to a person to be called, using a station line telephone through a telephone network, when the connection route of the external ordinary telephone is set to a transmission route for a station line telephone call mode.

It is preferable that the step for setting a call connection route has the step of receiving dial key input signals from the external ordinary telephone; making an Internet phone call to a person corresponding to a connection number by accessing an Internet telephone provider's server when the combination of the input dial keys indicates the connection number of the person to be called; and making a phone call by establishing a direct call connection to the person to be called through an Internet service provider when the combination of the input dial keys indicates the IP address of the person to be called.

It is preferable that in the step for receiving dial key input signals dial keys are input using number buttons of the telephone, or a keyboard, or a mouse.

It is preferable that if the combination of the input dial keys is a transmission route changing code for changing a call mode, the method further has the steps of switching the transmission route of the external ordinary telephone to an Internet phone call mode if the combination of the input dial keys is a transmission route changing code for changing a call mode and the currently set transmission route is a station line telephone mode; and switching the transmission route of the external ordinary telephone to a station line telephone call mode if the currently set transmission route is an Internet phone call mode.

It is preferable that the method further has the step of checking multiple registration of a connection number after inputting information through a user interface for membership registration in the IP relay server.

It is preferable that the method further has the step of automatically connecting to the person to be called using a station line telephone number if an Internet phone call using an IP address cannot be made.

### BRIEF DESCRIPTION OF THE DRAWINGS

FIG. 1 shows the structure of a system for a conventional Internet call;

FIG. 2 shows the structure of a system according to a preferred embodiment of the present invention, in which one telephone is used both for a station line telephone call and an Internet call;

FIG. 3 is a block diagram of a station line telephone and an Internet phone interface apparatus according to a preferred embodiment of the present invention;

FIG. 4 is a diagram of the structure for connecting each computer and an IP relay server system according to a preferred embodiment of the present invention and shows the content stored in the database of the IP relay server;

FIG. 5 shows a process for sending messages between members and an IP relay server according to a preferred embodiment of the present invention,

FIG. 6 is a flowchart of control of operations for making an Internet phone call using an external telephone according to a preferred embodiment of the present invention,

FIG. 7 shows an example of a user interface screen for member registration in the IP relay server 408;

FIGS. 8A and 8B show examples of application program screens of a telephone interface apparatus 200;

FIG. 9 is a flowchart of an algorithm in an IP relay server according to a preferred embodiment of the present invention; and

FIGS. 10A through 10H show a flowchart of an algorithm for operations in a computer program according to a preferred embodiment of the present invention.

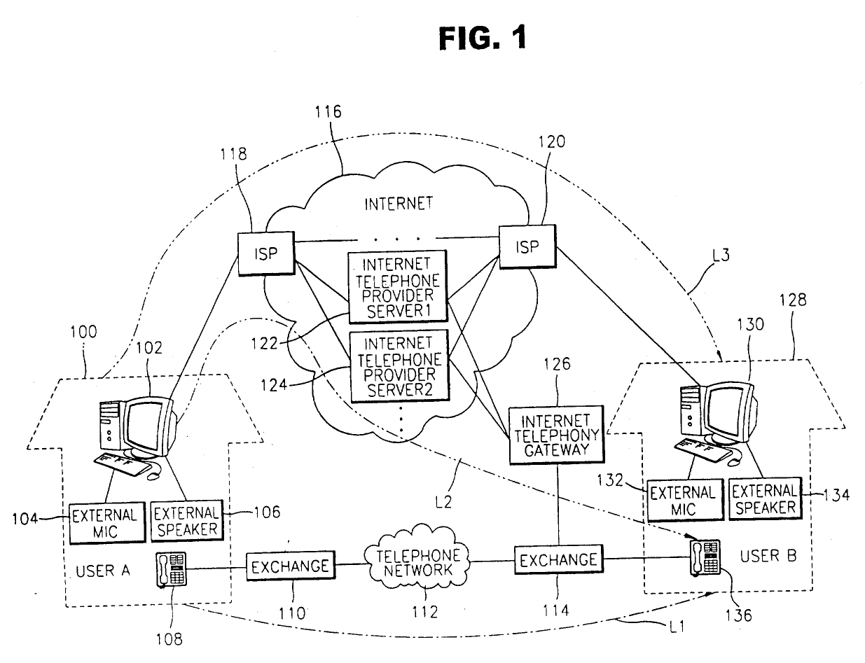

### BEST MODE FOR CARRYING OUT THE INVENTION

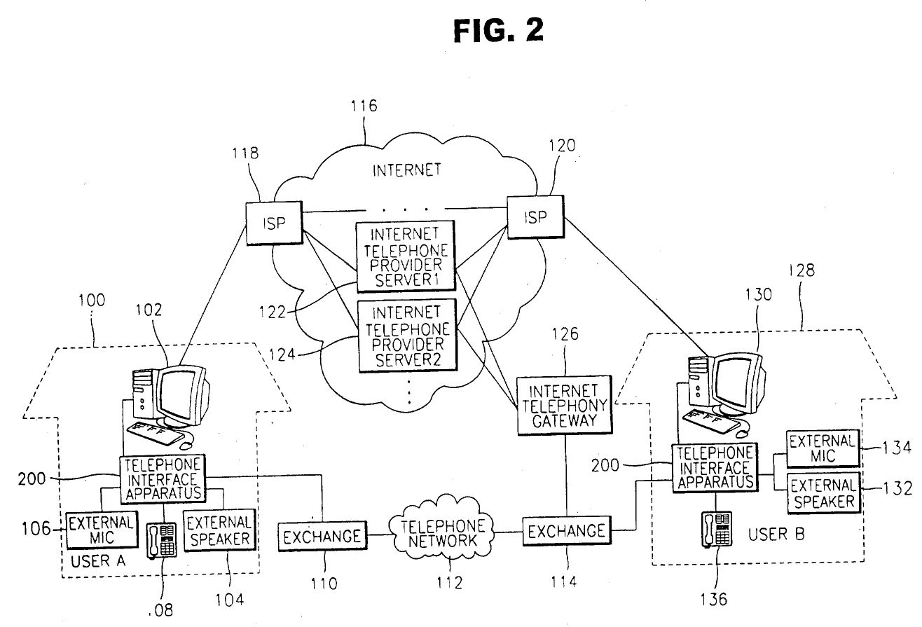

FIG. 2 shows the structure of a system according to a preferred embodiment of the present invention, in which one telephone is used both for a station line telephone call and an Internet call.

Referring to FIG. 2, the structure of the Internet phone system according to the preferred embodiment of the present invention includes a telephone interface apparatus 200 installed between an external telephone 108 (136) and a PC 102 (130), instead of a microphone and a speaker, which the user PC 102 (130) has to always have, so that an Internet phone call is made through the external telephone 108 (136).

That is, an audio signal, which is transmitted from the other side and output from the PC 102 (130), is made to be output from the handset of the external telephone 108 (136) through the telephone interface apparatus 200. Meanwhile, an audio signal, which is input through the handset of the external telephone 108 (136) and to be transmitted to the other side, is made to be input to the audio input signal processing unit of the PC 102 (130) through the telephone interface apparatus 200. Therefore, without a microphone and a speaker which the PC 102 (130) needed, an Internet phone call can be made using an external telephone.

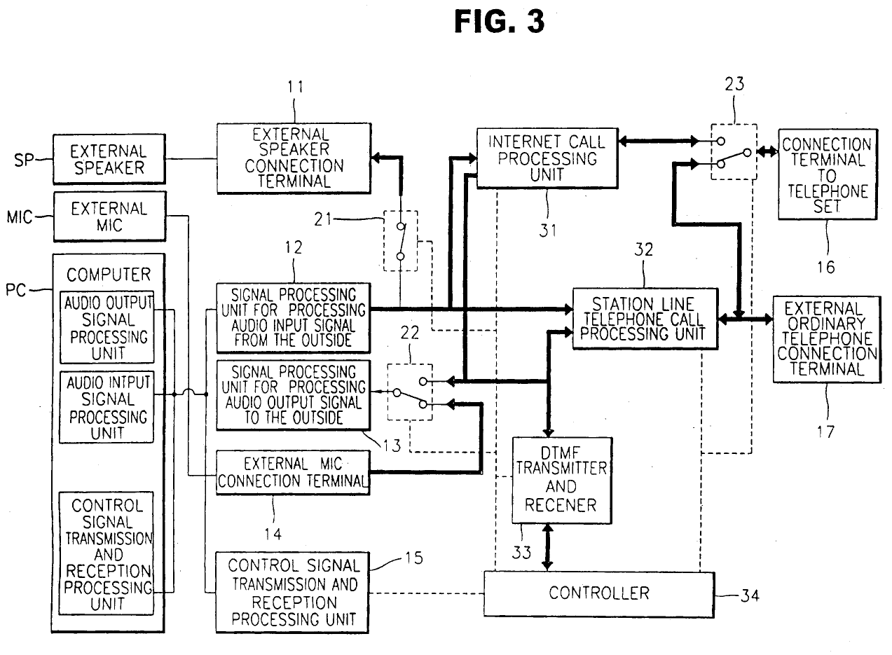

FIG. 3 is a block diagram of a station line telephone and an Internet phone interface apparatus according to a preferred embodiment of the present invention.

Referring to FIG. 3, when the user desires to make a station line telephone call (station line telephone mode) a first relay 23 connects the external telephone 108 to a station line telephone line. When the user desires to make an Internet phone call (Internet phone call mode), the first relay 23 is switched by control of a controller 34 and connects the external telephone 108 to an Internet call processing unit 31.

A second relay 21 is switched by control of the controller 34. In wait state, when the handset is hung up, or in a station line telephone mode, the second relay 21 connects a signal processing unit for processing an audio signal from the outside 12, to an external speaker connection terminal 11. In Internet phone call mode, the second relay 21 does not connect the signal processing unit for processing an audio signal from the outside 12 to the external speaker connection terminal 11. At this time, the external speaker (SP) does not make a sound.

However, use can manipulate so that the signal processing unit for processing an audio signal from the outside 12 is connected to the external speaker connection terminal 11. At this time, conversation of the Internet phone call can be heard also to persons near the external speaker (SP).

A third relay 22 is switched by control of the controller 34. In wait state, when the handset is hung up, or in a station line telephone mode, the third relay 22 connects a signal processing unit for processing an audio output signal to the outside 13 to an external microphone connection terminal 14 so that an audio signal input from an external microphone (MIC) is input to an audio input signal processing unit of the PC through the signal processing unit for processing an audio output signal to the outside 13. In Internet phone call mode, the third relay 22 connects the Internet call processing unit 31 to the external microphone connection terminal 14 so that an audio signal input from the handset of the external telephone 108 is input to the audio input signal processing unit of the PC through the signal processing unit for processing an audio output signal to the outside 13. A DTMF transmitter and receiver 33 detects a dial number input from the dial key of the external telephone 108, provides the number to the controller 34, and receives a dial number from the controller 34 and sends the dial number to the station line telephone line through a station line telephone call processing unit 32.

The Internet call processing unit 31 has at least a subscriber line interface circuit (SLIC) which connects the external telephone 108 to a subscriber line; an alarm sound generating unit for an incoming station line telephone call, which alerts the user if a station line telephone call incomes when the user is talking over the Internet phone; an off-the-hook detection unit for detecting the off-the-hook state of the external telephone and informing the controller 34 of the state; a dial tone generating unit for generating a dial tone, as an exchange does, when the external telephone is off the hook; and a ring sound generating unit for generating a ring sound, which is different from a ring sound for an incoming station line telephone call, in the external telephone when an Internet phone call incomes.

The station line telephone call processing unit 32 has at least a station line telephone call detection unit for detecting an incoming station line telephone call; an alarm sound generating unit for an Internet call, which alerts the user if an Internet phone call comes when the user is talking over the station line telephone; and an off-the-hook detection unit for detecting the off-the-hook state of the external telephone.

A control signal transmission and reception processing unit 15 is inserted into a serial or parallel communications port, or a universal serial bus (USB), or a slot of a PC, and interfaces the telephone interface apparatus 200 with the PC for transmitting and receiving data.

The controller 34 controls the overall operations of the telephone interface apparatus 200, and internally has a memory for storing operation programs and various reference data, and temporarily storing data which occurs during execution of various operations in the telephone interface apparatus 200 according to the operation programs.

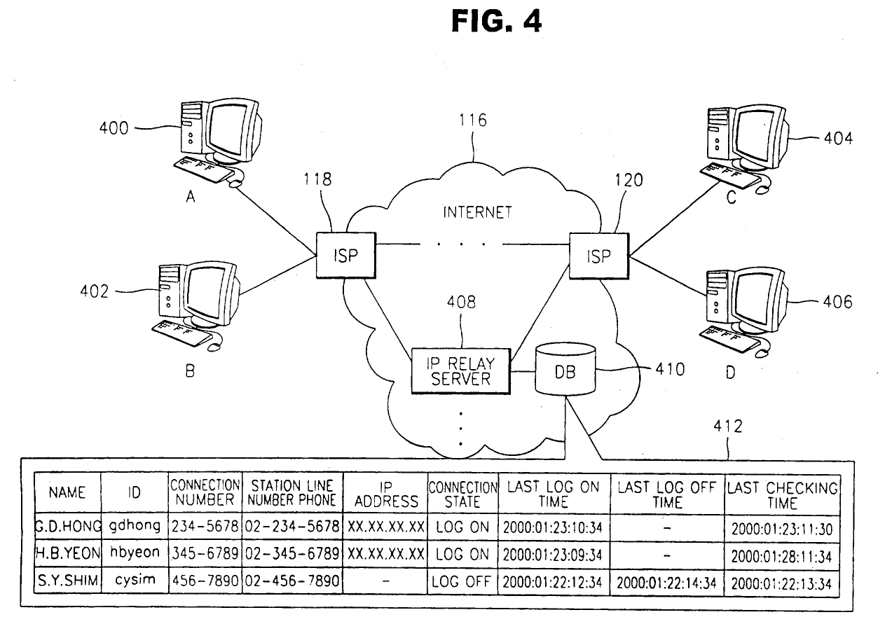

FIG. 4 is a diagram of the structure for connecting each computer and an IP relay server system according to a preferred embodiment of the present invention and shows the content stored in the database of the IP relay server.

Referring to FIG. 4, an IP relay server 408 according to the preferred embodiment of the present invention stores a lookup table 412, which has fixed IP addresses or variable IP addresses of a plurality of PCs 400-406 which are connected to the Internet through ISPs 118 and 120, in a database 410 as shown in FIG. 4. If a first PC requests the IP address of a second PC, the IP relay server 408 provides the first PC with the current IP address of the second PC. Therefore, in an Internet phone call using an IP address, the calling PC does not need to confirm the IP address of the called PC in advance, because the IP relay server 408 provides the IP address and the calling PC can make a phone call using the received IP address. Accordingly, the inconvenience of confirming in advance the IP address of a person to be called can be removed.

The content 412 of the database 410 includes members' names, IDs, connection numbers, station line telephone numbers, IP addresses, current connection states, last log on times, last log off times, last checking times, etc. Each of the connection numbers is a fixed number assigned to a user, just like a telephone number. Each of the station line telephone number is a station line telephone number of a user.

There are two types of the current connection states, log on and log off states. The log on state indicates that a user accesses the IP relay server 408, informs the IP relay server 408 of the user's IP address, and then accesses the IP relay server 408 within a predetermined time (for example, within 30 minutes) and maintains the connection. If a user who accessed once the IP relay server 408 does not access the IP relay server 408 within a predetermined time, the IP relay server 408 directly accesses the user PC, using the user's IP address which the IP relay server 408 has at that time, retrieves member information, compares the retrieved member information with the member information the IP relay server 408 has, and determines whether the member logs on or off. The last log on time means the last time the member accessed the IP relay server 408, the last log off time means the last time the member logged off the IP relay server 408, and the last checking time means the last time the IP relay server 408 tries to access the member, using the member's IP address.

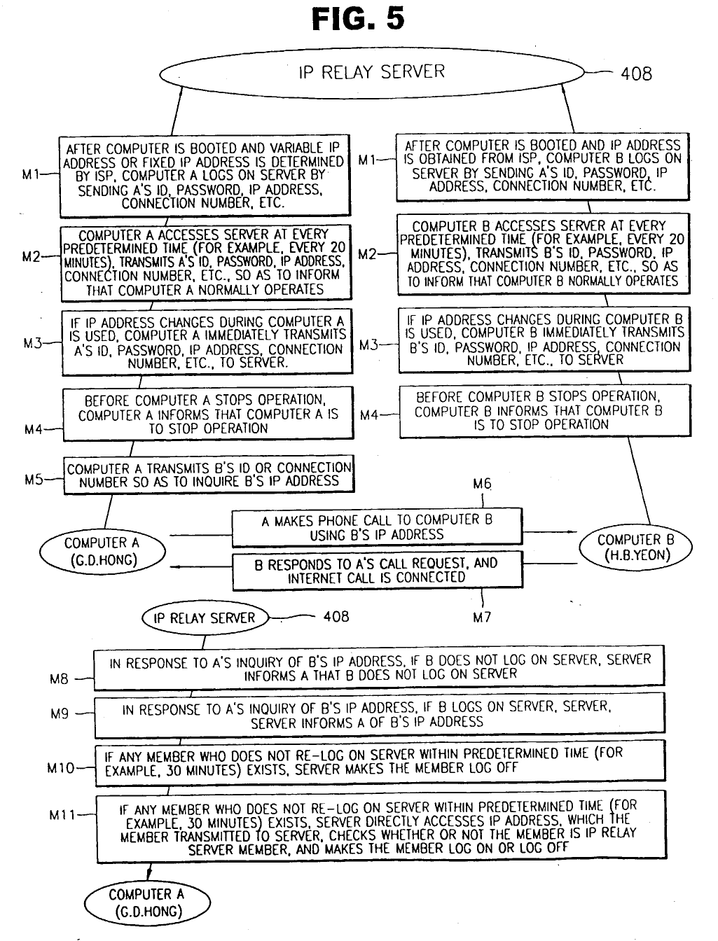

FIG. 5 shows a process for sending messages between members and an IP relay server according to a preferred embodiment of the present invention.

Referring to FIG. 5, as in M1, after a computer is booted, the computer access the Internet 116 and logs on the server by sending the computer's ID, password, IP address, connection number, etc. As in M2, the computer accesses the IP relay server 408 at every predetermined time, and transmits the computers ID, password, IP address, connection number, etc., to inform that the computer normally operates. As in M3, if the IP address changes due to some reasons, the computer immediately informs the IP relay server 408 of the changed IP address.

If the computer desires to inquire the IP address of another person desired to be called, the computer can inquire the IP address by sending the connection number of ID of the person. As in M4, before the computer stops operation, the computer informs the IP relay server 408 that the computer is to stop operation. As in M5, when A (for example, G.D.Hong) inquires the IP address of B (for example, H.B.Yeon) of the IP relay server 408, the IP relay server 408 informs A of the B's IP address if B logs on, and if B does not log on, informs A that B does not log on. In M6, A directly makes an Internet phone call to B, and in M7, with B's response, an Internet phone call is connected between A and B.

As in M8-M11, if any member, who does not re-log on the server within a predetermined time, exists, the server processes the member as logged off, or the server directly accesses the member with an IP address which is known to the server at that time, checks if the member is an IP relay server member, and then processes the member as logged on or logged off.

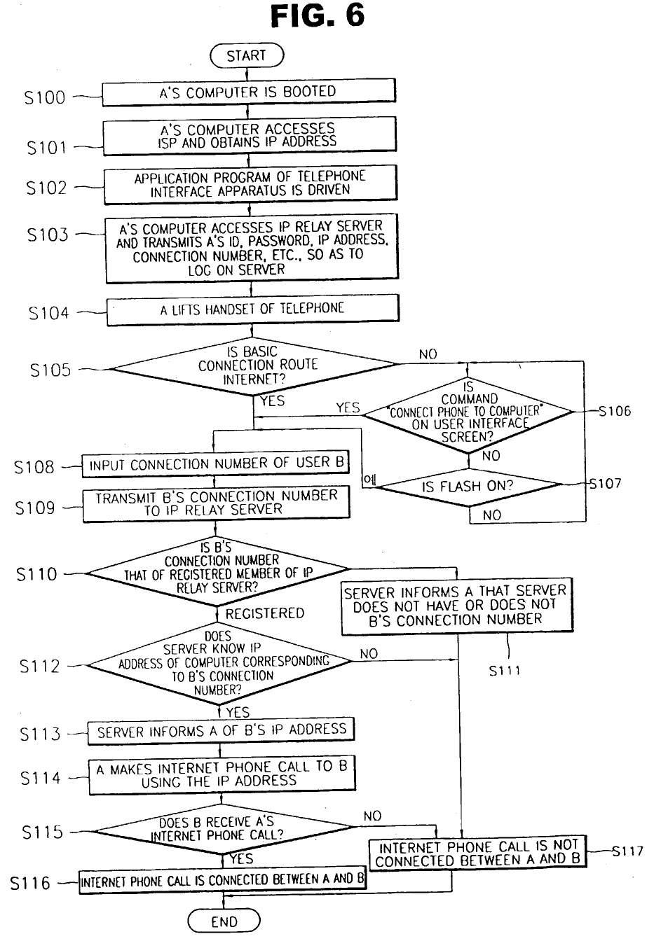

FIG. 6 is a flowchart of control of operations for making an Internet phone call using an external telephone according to a preferred embodiment of the present invention.

Referring to FIG. 6, it is assumed that A makes an Internet phone call to B. First, when A turns on the computer, A's computer is booted in step S100. A's compute accesses ISP 118 (120) and obtains a proper IP address in step S101.

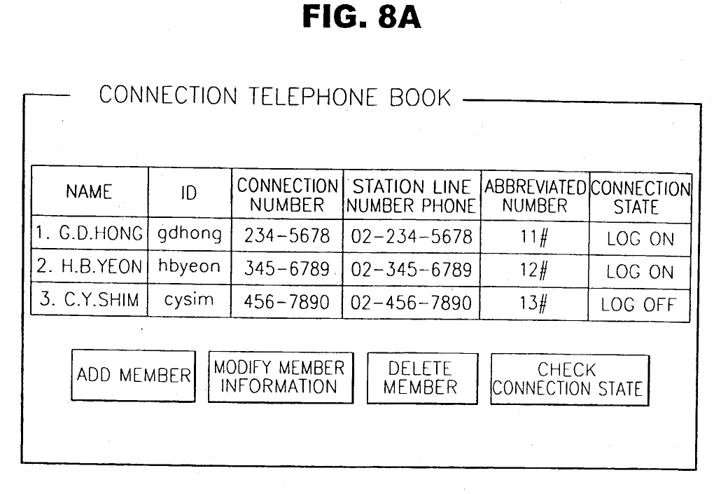

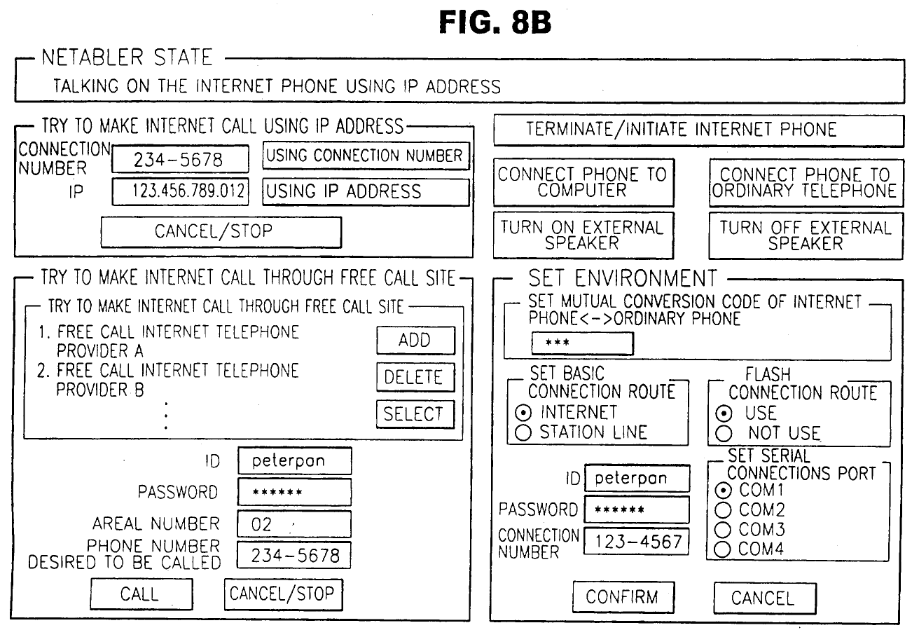

After step S101, if A desires to make an Internet phone call using an external telephone (108, 136), A executes the application program, which operates the telephone interface apparatus 200.and is installed in advance in A's PC according to the embodiment of the present invention, in step S102. Also in step S102, the user interface screen (FIG. 8) of the application program of the telephone interface apparatus 200 is displayed on the monitor of the A's PC. A's computer logs on the IP relay server 408 by automatically transmitting A's ID, password, IP address, connection number, etc., in step S103. By doing so, an environment for making an Internet phone call is set.

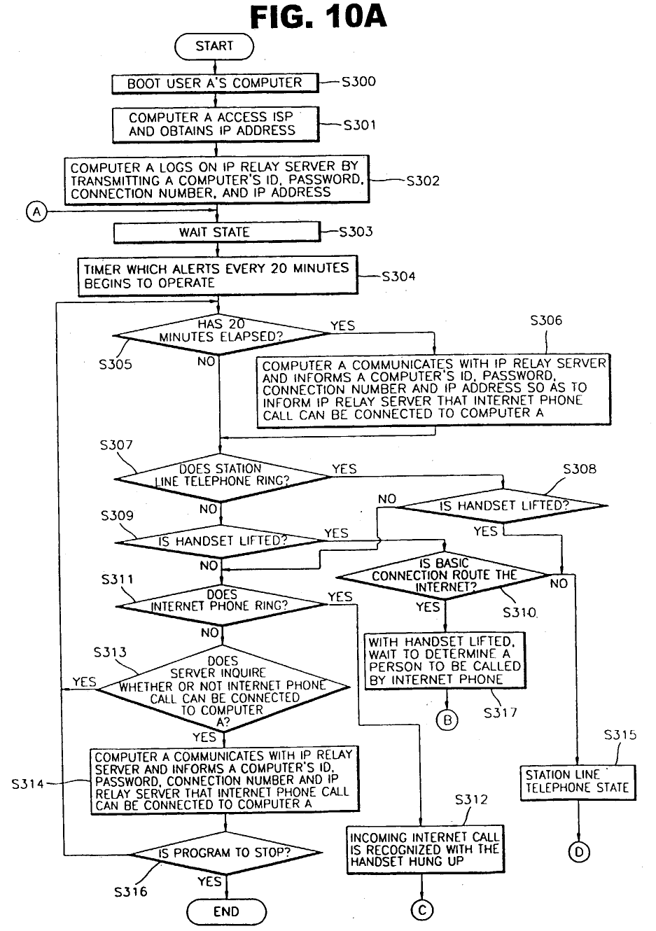

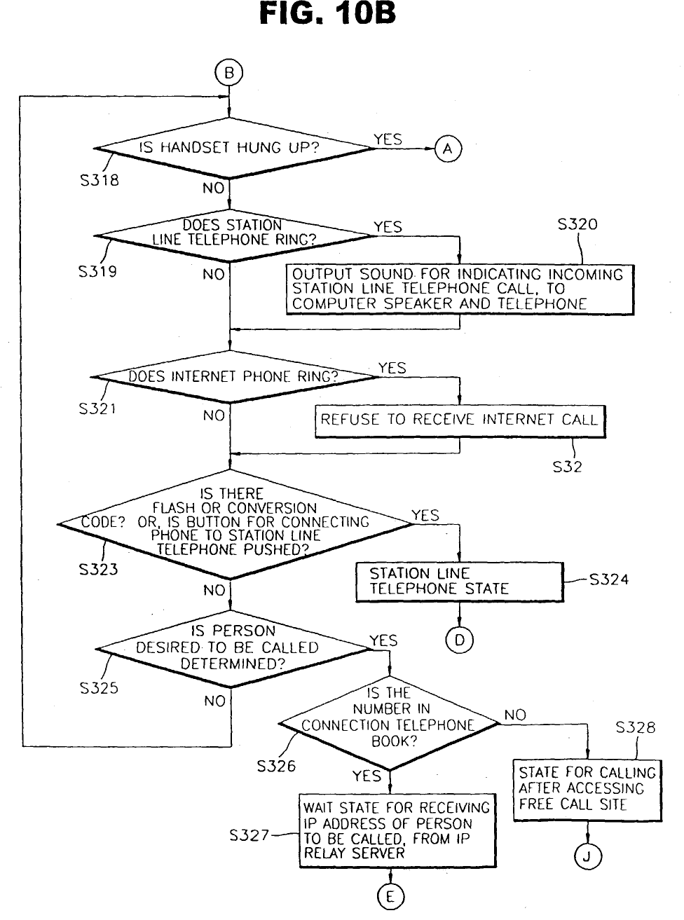

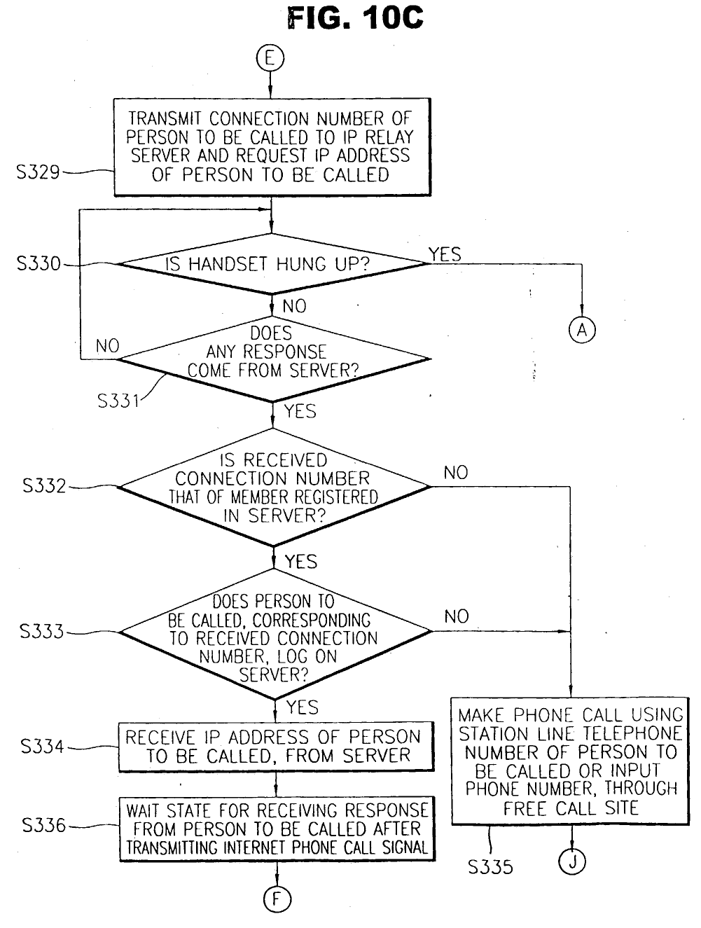

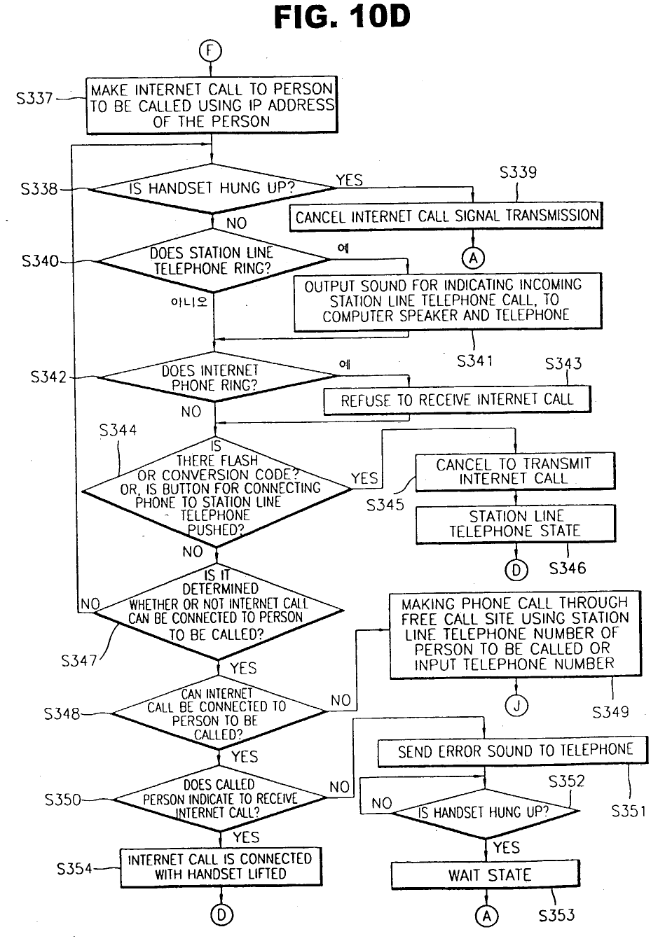

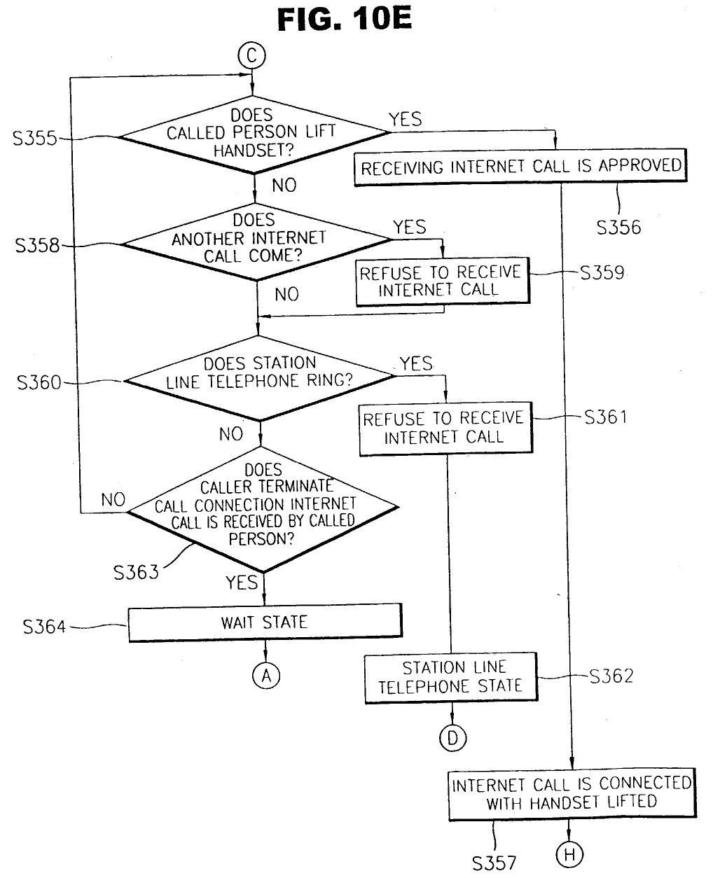

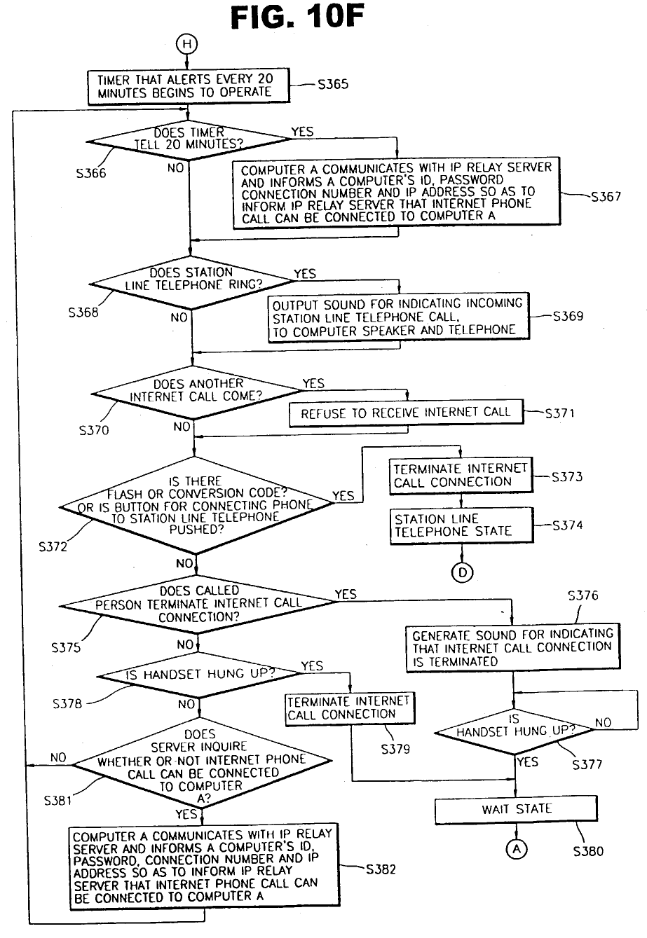

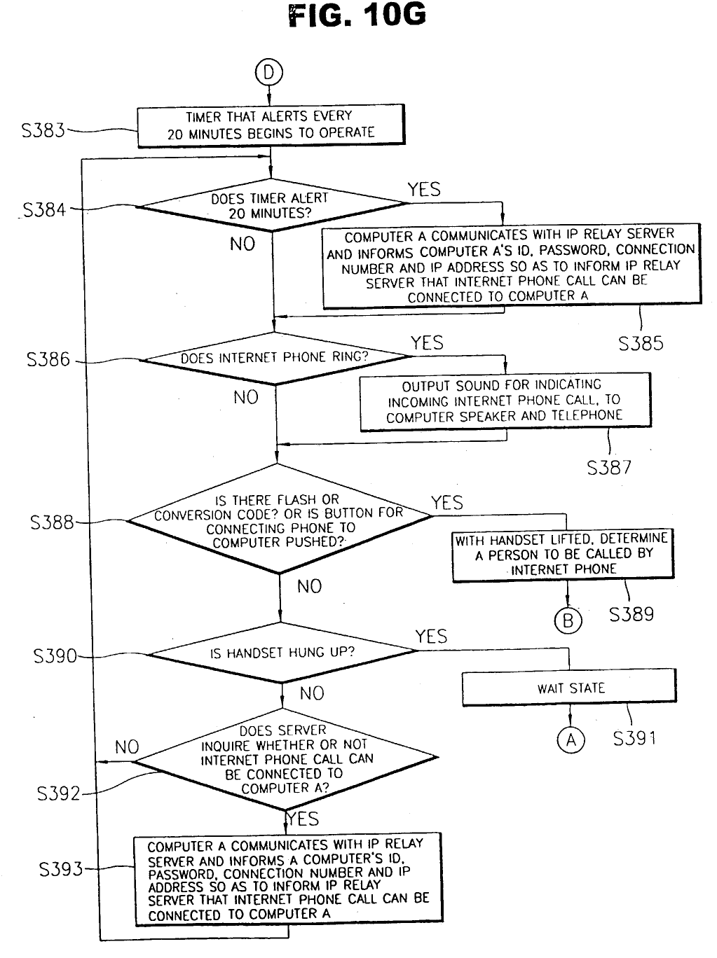

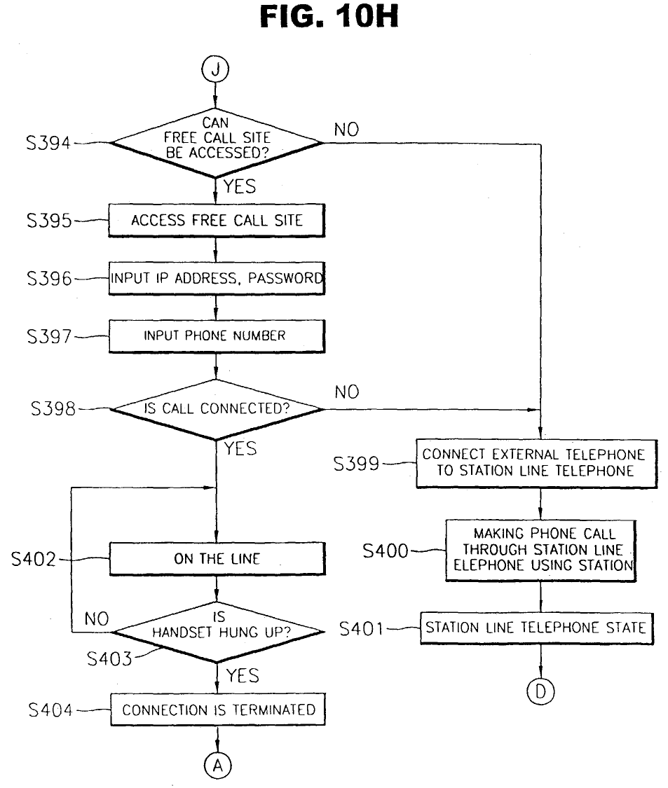

Then, A lifts the handset of the telephone in step S104. If the basic connection route in the environment setting item of FIG. 10 is the Internet in step S105, or if a command “connect phone to computer” appear on the user interface screen in step S106, or if flash is on with the telephone connected to the station line telephone line in step S107, A can input the connection number of a person desired to be called (for example, B) using the Internet phone. Input in step S108 may be done by the number buttons of the telephone or the keyboard. The application program receives this connection number and transmits the number to the IP relay server 408 in step S109. The IP relay server 408 checks if the connection number is that of a registered member in step S110. If the IP relay server 408 knows the IP address of the member corresponding to the connection number in step S112, the IP relay server 408 informs A of the IP address in step S113. If the connection number is not registered in step S110, the IP relay server 408 informs A that the IP relay server 408 does not have or does not know the connection number in step S111. After steps S111 and S112, or if B does not receive A's Internet phone call in step S115, an Internet phone call is not connected between A and B in step S117.

A makes an Internet phone call to B using thus obtained IP address in step S114. It is checked whether or not B receives the Internet phone call in step S115, and if B receives the Internet phone call in step S115, the Internet phone call is connected between A and B in step S116.

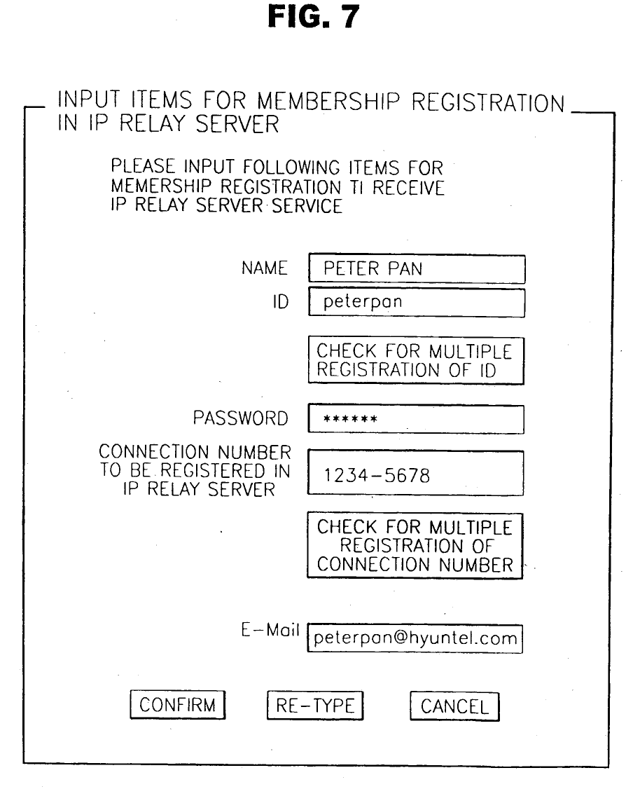

FIG. 7 shows an example of a user interface screen for member registration in the IP relay server 408. For registration, a user inputs the user's name, ID, password, connection number to be registered in the IP relay server 408, and email address.

FIGS. 8A and 8B show examples of application program screens of a telephone interface apparatus 200. As shown in FIG. 8B, the user interface screen for controlling main operations of the telephone interface apparatus 200 is displayed on the PC monitor. In a connection telephone book of FIG. 8A, information on persons to whom the user frequently makes phone calls. If the user double-clicks on a line of them, an Internet phone call is tried using the IP address of the person of the line.

If the Internet phone call is failed, an Internet phone call to the person is automatically tried using the person's ordinary telephone number through an Internet free call site. If the Internet phone call through the Internet free call site is also failed, a phone call is automatically tried using the station line telephone line. The abbreviated number in FIG. 8A is a two digit number. After pushing two numbers and then pushing ‘#’ button, an Internet phone call is made to the person of the abbreviated number. The connection state indicates whether or not a person in the book is presently connected to the P relay server 408. If ‘add member’ button is clicked on, a member can be added to the connection telephone book If one line is selected and ‘modify member information’ button is clicked on, the member's name, ID, connection number, ordinary telephone number, and abbreviated number can be modified. If ‘delete member’ button is clicked on, a member in the connection telephone book is selected and deleted. If ‘check connection state’ button is clicked on, information on the current connection states of members in the connection telephone book is provided from the IP relay server 408 and updated.

A character string showing the current state of the telephone interface apparatus 200 is output below ‘Netabler state’ at the top of FIG. 8B. In ‘Try to make Internet phone call using IP address’ box, the user inputs directly the connection number or the IP address of a person to be called, and then, can make a phone call by pushing ‘using connection number’ button or ‘using IP address’ button. ‘Cancel/stop’ button and ‘Terminate/initiate Internet phone’ button are used to terminate a connected Internet call. If ‘Connect phone to computer’ button is pushed, the first relay 23 of FIG. 3 is manipulated so that the external telephone is connected to the Internet call processing unit. This button is used to connect the external telephone to the computer when the external telephone is connected to the station line telephone. If ‘Connect phone to station line telephone line’ button is pushed, the first relay 23 of FIG. 3 is manipulated so that the external telephone is connected to the station line telephone line. This button is used to connect the external telephone to the station line telephone when the external telephone is connected to the computer. If ‘Turn on external speaker’ button is pushed, the second relay 21 of FIG. 3 is manipulated so that the external speaker connection terminal 11 of FIG. 3 is connected to the signal processing unit for processing an audio input signal from the outside 12 of FIG. 3. If ‘Turn off external speaker’ button is pushed, the secondary relay 21 of FIG. 2 is manipulated so that the external speaker connection terminal 11 of FIG. 3 is disconnected to the signal processing unit for processing an audio input signal from the outside 12 of FIG. 3. In ‘Set environment’ box, a mutual conversion code can be set using ‘Set mutual conversion code of Internet phone <−> station line telephone’ button. If the mutual conversion code is buttoned during an Internet phone call state, the call state changes into a station line telephone state, and if the mutual conversion code is buttoned during a station line telephone state, the call state changes into an Internet phone call state. In ‘Set basic connection route’ box, if ‘Internet’ is selected, lifting the handset makes an Internet phone call state, and if ‘station line telephone’ is selected, lifting the handset makes a station line telephone state. In ‘Flash’ box, if ‘Use’ is selected, a response will be made to a flash transmitting to the telephone, and if ‘Not use’ is selected, no response will be made to a flash transmitting to the telephone. ‘Flash’ can be used in mutual conversion of an Internet phone call and a station line telephone call. ‘ID’, ‘Password’, and ‘Connection number’ are information on a user. A communications port between the telephone interface apparatus 200 and the computer is set in ‘Serial communications port’ box.

An Internet phone call may be made through a free call site. In ‘Try to make Internet phone call through free call site’ box on the left of FIG. 8B, if ‘Add’ button is pushed, a free call site can be added, and if ‘Delete’ button is pushed, a selected site is deleted. If ‘Select’ button is pushed after selecting one of many free call sites included in the box, the selected site is used in making a phone call through a free call site. When a try to make a phone call using an IP address is failed, a station line telephone number in the connection telephone book or the telephone number input through the telephone is used to make a phone call through the free call site which is selected at present. The ID and password are automatically input when each selected free call site is automatically accessed. When the user desires to manually make a phone call through a free call site, the user inputs an area1 number and a desired telephone number and pushes ‘Call’ button. If ‘Cancel/stop’ button is pushed, the call is canceled.

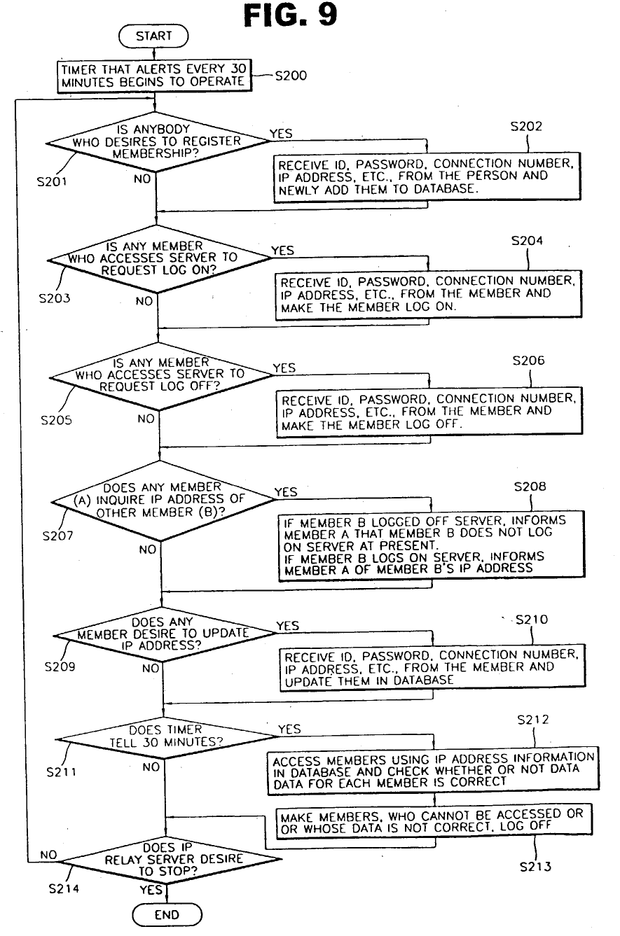

FIG. 9 is a flowchart of an algorithm in an IP relay server according to a preferred embodiment of the present invention.

Referring to FIG. 9, if power is provided to the IP relay server 408, a timer that makes an alert every predetermined time interval (for example, 30 minutes) starts to operate in step S200. If a person who desires to register as a member exists in step S201, the IP relay server 408 receives the ID, password, connection number, IP address, etc., from the person and adds the person as a new member to the database 410 in step S202. If a registered member accesses the IP relay server 408 to log on in step S203, the IP relay server 408 receives the ID, password, connection number, IP address, etc., from the member, and if the information is correct makes the member log on in step S204.

If a member who is logged on desires to log off in step S205, the IP relay server 408 receives the ID, password, connection number, IP address, etc., from the member, and if the information is correct makes the member log off in step S206. If a member tries to inquire the IP address of another member in step S207, the IP relay server 408 checks whether the inquired member logs on or off, and inform the inquiring member of the checking result in step S208. If a member desires to update the member's IP address because of changes due to some causes in step S209, the IP relay server 408 receives the ID, password, connection number, IP address, etc., from the member and if the information is correct updates the IP address of the database 410 in step S210. In step S211 it is determined whether or not the timer indicates that 30 minutes elapses. If the predetermined time elapses, it is determined whether or not data of members in the database is correct, in step S212. The IP relay server makes members, whose data is not correct, log off in step S213. If the IP relay server 408 desires to stop operation in step S214, the IP relay server 408 stops operation.

FIGS. 10A through 10H show a flowchart of an algorithm for operations in a computer program according to a preferred embodiment of the present invention.

Referring to FIGS. 10A through 10H, computer A 400 is booted, as shown in FIG.10A, in step S300. Computer A 400 accesses an ISP 118 or 120 and obtains an IP address in step S301. Computer A 400 sends its ID, password, connection number, and IP address to the IP relay server 408 and logs on the IP relay server 408 in step S302, and starts a timer which alerts every predetermined time (for example, 20 minutes) in step S304.

It is determined whether or not a predetermined time (20 minutes) has elapsed, in step S305. If the predetermined time has elapsed, computer A 400 informs the IP relay server 408 that an Internet phone call to computer A 400 can be connected, by sending the ID, password, connection number, and IP address of computer A 400 to the IP relay server 408 in step S306. If in step S305 it is determined that the predetermined time (20 minutes) has not elapsed, or if the step S306 is performed, it is determined whether or not a station line telephone rings, in step S307. If the station line telephone rings in step S307, it is determined whether or not the handset of the telephone is lifted, in step S309. If the handset is lifted, it is determined whether or not a basic connection route is is the Internet, in step S310. If the handset is not lifted in step S308 or S309, it is determined whether or not an Internet phone calls, in step S311. If the Internet phone rings in step S309, it is recognized that the Internet phone rings while the station line telephone handset is not lifted, in step S312. If the Internet phone does not ring in step S311, it is determined whether or not the IP relay server 408 inquires if an Internet phone call can be connected to computer A, in step S313. If the IP relay server 408 does not inquire in step S313, the step S305 is performed. If the IP relay server 408 inquires in step S313, computer A 400 informs the IP relay server 408 that an Internet phone call can be connected to computer A, by sending the ID, password, connection number, and IP address of computer A 400, in step S314. If the computer program is to stop in step S316, and if the computer program is not to stop in step S316, step S305 is performed.

If the handset is lifted in step S308, or if the basic connection route is not the Internet in step S310, a station line telephone state is indicated in step S315. If the basic connection route is the Internet in step S310, user A waits to determine a person to be called by the Internet phone, with the handset lifted, in step S317.

FIG. 10B is a flowchart of a process for determining a person to be called by the Internet phone, with the handset lifted. After step S317 in which user A waits to determine a person to be called by the Internet phone, with the handset lifted, it is determined whether or not the handset is hung up, in step S318. If the handset is hung up in step S318, the wait state of S303 is performed. If the handset is not hung up in step S318, it is determined whether or not the station line telephone rings, in step S319. If the station line telephone rings in step S319, a sound for indicating an incoming station line telephone call is output through the speaker and telephone so that the user can be alerted, in step S320.

If the station line telephone does not ring in step S319, or if step S320 is performed, it is determined whether or not the Internet phone calls, in step S321. If the Internet phone calls in step S321, receiving the Internet phone call is refused in step S322 because computer A 400 is trying to make an Internet phone call. If the Internet phone does not call in step S322, or if step S322 is performed, it is determined whether or not there is a flash or a conversion code, or it is determined whether or not a button for connecting the telephone to a station line telephone line is pushed, in step S323. If there is a flash or a conversion code, or the button for connecting the telephone to a station line telephone line is pushed in step S323, the telephone enters into a station line telephone state in step S324.

If there is not a flash nor a conversion code, or the button for connecting the telephone to a station line telephone is not pushed in step S323, it is determined whether or not a person to be called is determined, in step S325. If a person to be called is not determined in step S325, step S318 is performed. To determined a person to be called in step S325, number buttons of the telephone is pushed, numbers are input using the mouse of the computer, number buttons of the keyboard is pushed, or a person in the connection telephone book of FIG. 8A is selected and double-clicked on. If a person to be called is determined in step S325, it is determined whether or not the person to be called is included in the connection telephone book, in step S326. If the person to be called is included in the connection telephone book in step S326, computer A 400-406 enters into a wait state for receiving the IP address of the person to be called from the IP relay server 408, in step S327. If the person to be called is not included in the connection telephone book, computer A 400-406 tries to make a phone call using a free call site in step S328.

FIG. 10C is a flowchart of a process for receiving the IP address of a person to be called from the IP relay server 408.

If computer A 400-406 enters into a wait state for receiving the IP address of the person to be called from the IP relay server 408 in step S327, computer A 400 requests the IP address of the person to be called, by sending the connection number of the person to be called to the IP relay server 408, in step S329. After step S329 is performed, it is determined whether or not the handset is hung up, in step S330. If the handset is hung up in step S330, step S303 of a wait state is performed. If the handset is not hung up in step S330, it is determined whether or not any response is sent by the IP relay server 408, in step S331. If there is no response from the IP relay server 408 in step S331, step S330 is performed. If there is any response from the IP relay server 408 in step S331, it is determined whether or not the received connection number is the connection number of a member registered in the IP relay server 408, in step S332.

If the received connection number is the connection number of a member registered in the IP relay server 408 in step S332, it is determined whether or not the person, who is to be called and corresponds to the received connection number, is logged on the IP relay server 408, in step S333. If the person is logged on in step S333, computer A receives the IP address of the person from the IP relay server 408 in step S334. If the received connection number is the connection number of a member who is not registered in the IP relay server 408 in step S332, or if the person is not logged on the IP relay server 408 in step S333, computer A 400-406 automatically accesses a free call site in step S335, and tries to make a phone call, using a station line telephone number, which is input in the connection telephone book of FIG. 8A in advance, or using an input telephone number. If the IP address of the person to be called is received by computer A 400-406 in step S334, computer A 400-406 makes an Internet phone call and waits for a response from the called person, in step S336.

FIG. 10D is a flowchart of a process for waiting for a response from the called person, after directly making an Internet phone call using the IP address determined in the previous steps.

If computer A 400-406 waits for a response from the called person in step S336 after making an Internet phone call, computer A 400-406 makes an Internet phone call to the person to be called in step S337, and it is determined whether or not the handset is hung up in step S338. If the handset is hung up in step S337, the Internet phone call is canceled in step S339 and step 303 of a wait state is performed.

If the handset is not hung up in step S338, it is determined whether or not the station line telephone rings, in step S340. If the station line telephone rings in step S340, a sound for indicating an incoming station line telephone call is output to the computer speaker and the telephone in step S341. If the station line telephone does not ring in step S340, or if step S341 is performed, it is determined whether or not the Internet phone rings, in step S342. If the Internet phone rings in step S342, receiving the Internet phone call is refused in step S343.

If the Internet phone does not ring in step S342, or if step S343 is performed, it is determined whether or not there is a flash or a conversion code, or whether or not the button for connecting the telephone to a station line telephone line is pushed, in step S344. If there is a flash or a conversion code, or the button for connecting the telephone to a station line telephone line is pushed in step S344, the Internet phone call is canceled in step S345, and computer A 400-406 enters into a station line telephone line state in step S346.

If there is not a flash nor a conversion code, or the button for connecting the telephone to a station line telephone line is not pushed in step S344, it is determined whether or not it is possible to determine whether or not an Internet phone call can be connected to the person to be called in step S347. If it is not determined yet whether or not an Internet phone call can be connected to the person to be called in step S347, step S338 is performed. If it is determined whether or not it is possible to determined whether or not an Internet phone call can be connected to the person to be called in step S347, it is determined whether or not an Internet phone call can be connected to the person to be called, in step S348. If it is determined that an Internet phone call cannot be connected to the person to be called in step S348, a phone call is made through a free call site in step S349. If it is determined that an Internet phone call can be connected to the person to be called in step S348, computer A 400-406 waits for a response from the called person in step S350. If the called person indicates to receive the phone call, user A talks with the called person through the Internet phone in step S354. If the called person indicates not to receive the phone call in step S350, it is determined whether or not the handset is hung up, in step S352. If the handset is not hung up in step S352, step S352 is again performed. If the handset is hung up. in step S352, computer A 400 enters into a wait state in step S353.

FIG. 10E is a flowchart of a process when an Internet call incomes with the handset hung up.

If it is recognized that the Internet phone rings while the station line telephone handset is not lifted, in step S312 of FIG. 10A, it is determined whether or not the called person lifts the handset ins step S355. If the called person lifts the handset, receiving the Internet phone call is approved in step S356, and the Internet phone call is connected with the handset lifted in step S357.

If the called person does not lift the handset in step S355, it is determined whether or not another Internet phone call comes in step S358. If another Internet phone call comes in step S358, receiving the Internet phone call is refused in step S359. If another Internet phone call does not come in step S358, or if step S359 is performed, it is determined whether or not the station line telephone rings, in step S360. If the station line telephone rings in step S360, receiving the Internet phone call is refused in step S361, and computer A 400 enters into a wait state in step S362.

If the station line telephone does not ring in step S360, it is determined whether or not the caller hung up the phone before the called person receives the Internet phone call, in step S363. If the caller does not hang up the phone before the called person receives the Internet phone call in step S363, step S355 is performed. If the caller hung up the phone before the called person receives the Internet phone call in step S363, computer A 400 enters into a wait state in step S364.

FIG. 10F is a flowchart of a process in which an Internet call is connected with the handset lift.

If an Internet phone call is connected with the handset lifted in step S357, a timer that alerts every predetermined time (for example, 20 minutes) begins to operate in step S365. It is determined whether or not the predetermined time has elapsed, in step S366. Whenever the predetermined time elapsed, computer A 400 informs the IP relay server 408 that an Internet phone call to computer A 400 can be connected, by sending the ID, password, connection number, and IP address of computer A 400, in step S367.

If the predetermined time has not elapsed in step S366, or if step S367 is performed, it is determined whether or not the station line telephone rings in step S368. If the station line telephone rings in step S368, a sound for indicating the incoming station line telephone call is output to the speaker and telephone in step S369.

If the station line telephone does not ring in step S368, or if step S369 is performed, it is determined whether or not another Internet phone call comes in step S370. If another Internet phone call comes in step S370, receiving the Internet phone call is refused in step S371. If another Internet phone call does not come in step S370, or if step S371 is performed, it is determined whether or not there is a flash or a conversion code, or whether or not the button for connecting the telephone to a station line telephone is pushed, in step S372. If there is a flash or a conversion code, or the button for connecting the telephone to a station line telephone is pushed in step S372, the Internet phone call is terminated in step S373. If the Internet phone call is terminated in step S373, computer A 400 enters into a station line telephone state in step S374.

If there is not a flash nor a conversion code, or the button for connecting the telephone to a station line telephone is not pushed in step S372, during talking over the phone it is determined whether or not the other party hung up first, in step S375. If the other party hung up first in step S375, a sound for indicating termination of the Internet phone call is generated in step S376. If the sound for indicating termination of the Internet phone call is generated in step S376, it is determined whether or not the handset is hung up in step S377. If the handset is not hung up in step S377, it is repeatedly determined whether or not the handset is hung up.

If the other party did not hang up first in step S375, it is determined whether or not the handset is hung up in step S378. If the handset is hung up in step S378, the Internet phone call is terminated in step S379. If the handset is hung up in step S377, or if step S379 is performed, computer A 400 enters into a wait state in step S380.

If the handset is not hung up in step S378, it is determined whether or not the IP relay server 408 inquires whether or not an Internet phone call can be connected to computer A 400, in step S381. If the IP relay server 408 does not inquire in step S381, step S366 is performed. If the IP relay server 408 inquires whether or not an Internet phone call ca be connected to computer A 400 in step S381 during talking over the Internet phone, computer A 400 communicates with the IP relay server 408 and informs the IP relay server 408 that an Internet phone call can be connected to computer A 400, by sending the ID, password, connection number, and IP address, in step S382, and step S366 is performed.

FIG. 10G is a flowchart of events which can occur during a station line telephone call.

In the station line telephone state of step S374, a timer that alerts every predetermined (for example, 20 minutes) begins to operate in step S383. It is determined whether or not the predetermined time has elapsed, in step S384. Whenever the predetermined time has elapsed, computer A 400 informs the IP relay server 408 that an Internet phone call can be connected to computer A 400, by sending the ID, password, connection number, and IP address of computer A 400 to the IP relay server 408, in step S385.

If the predetermined time has not elapsed in step S384, or if step S385 is performed, it is determined whether or not the Internet phone rings, in step S386. If the Internet phone rings when the station line telephone call is connected in step S386, a sound for indicating the incoming Internet phone call is output to the computer speaker and the telephone in step S387. If the Internet phone does not ring in step S386, or if step S387 is performed, it is determined whether or not there is a flash or a conversion code, or the button for connecting the telephone to the computer is pushed, in step S388. If there is a flash or a conversion code, or the button for connecting the telephone to the computer is pushed in step S388, computer A 400 enters into a state in which a person to be called by the Internet phone is determined with the handset lifted, in step S389.

If there is not a flash nor a conversion code, or the button for connecting the telephone to the computer is not pushed in step S388, it is determined whether or not the handset is hung up, in step S390. If the handset is hung up in step S390, computer A 400 enters into a wait state in step S391.

If the handset is not hung up in step S390, it is determined whether or not the IP relay server 408 inquires whether or not an Internet phone call can be connected to computer A, in step S392. If the IP relay server 408 does not inquire in step S392, step S384 is performed. If the IP relay server 408 inquires in step S392, computer A 400 communicates with the IP relay server 408 and informs the IP relay server 408 that an Internet phone call can be connected to computer A 400, by sending the ID, password, connection number, and IP address of computer A 400, in step S393, and step S384 is performed.

FIG. 10H is a flowchart of a process for making a phone call through a free call site. Here, a free call site through which a phone call is tried is the free call site selected in FIG. 8B. First, it is determined whether or not the free call site can be accessed in step S394. If it is determined in step S394 that the free call site can be accessed, the free call site is accessed in step S395, the ID and password are automatically input in step S396, the station line telephone number of a person to be called is automatically input in step S397, and then it is determined whether or not the phone call is connected to the called person, in step S398. If the phone call is not connected in step S398, or if it is determined in step S394 that the free call site cannot be accessed, the external telephone is connected to the station line telephone in step S399, and a phone call is made using the station line telephone number of the person to be called through the station line telephone line in step S400. With direct dialing the station line telephone number, computer A 400 enters into a station line telephone state in step S401. If the phone call is connected to the called person in step S398, both parties talks over the phone in step S402. It is determined whether or not any party hangs up the handset, in step S403, and if any party hung up the handset, the call connection is terminated in step S404.

The present invention is not restricted to the above-described embodiments, and many variations are possible within the spirit and scope of the present invention. Therefore, the scope of the present invention is not determined by the description but by the accompanying claims.

Industrial Applicability

According to the present invention, when an Internet phone call is made, an audio output signal, which is received by an external terminal connected to an external telephone, is output to the handset of the external telephone, and an audio input signal, which is received by the external telephone, is input to an audio input signal processing unit of the external terminal so that an Internet phone call can be connected through the external telephone. By doing so, an Internet phone call using the external telephone is enabled. Also, a database of the IP addresses of a plurality of terminals connected to the Internet is made and when a first terminal requests the IP address of a second terminal the IP address of the second terminal is retrieved from the database and provided. By doing so, without passing through an Internet telephone provider, an Internet phone call using the IP address is enabled.

What is claimed is:

1. An apparatus for an Internet telephone interface, wherein an Internet phone call is made using an external ordinary telephone, the apparatus comprising:
an Internet call processing unit for transmitting an audio output signal, which is received by an external terminal, to the handset of the external ordinary telephone, and for providing an audio input signal, which is received by the external ordinary telephone, to an audio input signal processing unit of the external terminal;
a station line telephone call processing unit for detecting an off-the-hook state of the external ordinary telephone and detecting an incoming station line telephone call;
a dual tone multi-frequency (DTMF) transmitter and receiver for detecting a DTMF tone of a dial key of the external ordinary telephone and transmitting the DTMF tone to the station line telephone call processing unit;
a first switching unit for selectively connecting the external ordinary telephone to one of the station line telephone and the Internet;
a second switching unit for selectively switching the signal, which is output from the audio output signal processing unit of the external terminal and sent to a signal processing unit for processing an audio input signal from the outside, to an audio signal output unit to an external connection apparatus;
a third switching unit for selectively switching the signal, which is input to the audio input signal processing unit of the external terminal and sent to a signal processing unit for processing an audio output signal to the outside, to one of the Internet call processing unit and an audio signal input unit of the external connection apparatus;
a control unit for controlling the first switching unit in a station line telephone mode so that the external ordinary telephone is connected to a station line telephone, and controlling the first switching unit, the second switching unit, and the third switching unit in an Internet call mode so that the external ordinary telephone is connected to the Internet call processing unit, the audio signal output processing unit of the external terminal is connected to the receiver of the external telephone through the Internet call processing unit, and the audio signal input processing unit of the external terminal is connected to the transmitter of the external telephone through the Internet call processing unit; and
an input/output (I/O) interface unit for receiving and transmitting data between the external terminal and the telephone interface apparatus.

2. The apparatus of claim 1, wherein the Internet call processing unit comprises:
a subscriber line interface circuit for connecting the external connection apparatus and the external ordinary telephone with a subscriber line;
a unit for generating a ring sound in the external ordinary telephone when the Internet call incomes;
a unit for generating an alarm sound to indicate an incoming station line telephone call during an Internet phone call, by generating an alarm sound in the external ordinary telephone;
an off-the-hook detecting unit for detecting an off-the-hook state of the external ordinary telephone; and
a unit for generating a dial tone in the external ordinary telephone when the external ordinary telephone is off the hook.

3. The apparatus of claim 1, wherein the station line telephone processing unit comprises:
a unit for detecting an incoming station line telephone call;
a unit for generating an alarm sound in the external ordinary telephone when an Internet phone call incomes during a station line telephone call; and
a unit for detecting the off-the-hook state of the external ordinary telephone.

4. The apparatus of claim 1, wherein the switching units are implemented by relay devices or switching devices.

5. The apparatus of claim 1, wherein the external terminal is a personal computer.

6. An apparatus for an Internet telephone interface in an Internet protocol (IP) relay server system for making an Internet phone call using an IP address, the apparatus comprising:
a plurality of personal computers (PCs), each of which has an assigned IP address;
an Internet Service Provider (ISP) for connecting the plurality of PCS to the Internet; and
an IP relay server for storing an IP address, which is assigned to the PC of a member registered in the IP server system connected to the Internet, together with the name, identification (ID), connection number, and ordinary telephone number, for each member, and, when a first member requests the IP address of a second member, searching a database for the IP address of the PC, which the second member is using, and providing the IP address to the first member.

7. The apparatus of claim 6, wherein the IP address of each PC is a variable IP address of a fixed IP address.

8. A method for making an Internet phone call using an external ordinary telephone by using an apparatus for an Internet telephone interface, the method comprising the steps of:
outputting an audio output signal, which is received by an external terminal connected to an external ordinary telephone, to the handset of the external ordinary telephone when an Internet phone call is connected; and
inputting an audio input signal, which is received by the external ordinary telephone, to an audio input signal processing unit of the external terminal so that an Internet phone call is connected using the external ordinary telephone.

9. A method for making an Internet phone call using an external ordinary telephone by using IP addresses, the method comprising the steps of:
making a database of the IP address of a plurality of terminals connected to the Internet; and
searching the database for the IP address of a second terminal, when a first terminal requests the IP address of the second terminal, and providing the IP address to the first terminal so that the first terminal can make an Internet phone call to the second terminal.

10. A method for setting an initial environment of an Internet telephone interface apparatus in a method for making an Internet phone call using an external ordinary telephone, the method for setting an initial environment comprising the steps of:
starting an external terminal connected to the Internet telephone interface apparatus;
obtaining an IP address after accessing an Internet service provider's server through the external terminal; and
setting an initial environment of an application program of the Internet telephone interface apparatus implemented in the external terminal.

11. The method of claim 10, further comprising the steps of:
setting a basic connection route of the external ordinary telephone;
setting a mutual conversion code for changing the set connection route of the external ordinary telephone; and
setting a connection number, an ID, a password, a serial communications port, a mutual conversion code, and setting default states for ‘cancel/stop’ button, ‘Internet phone call termination/initiation’ button, ‘connect telephone to computer’ button, ‘connect telephone to ordinary telephone line’ button, ‘turn on external speaker’ button, ‘turn off external speaker’ button, and ‘flash’ button.

12. A method for an Internet telephone interface, for making an Internet phone call in an apparatus for an Internet telephone interface, using an external ordinary telephone, the method for an Internet telephone interface comprising the steps of:
checking the basic connection route of the external ordinary telephone;
setting a call connection route to a person to be called through the Internet if the basic connection route is set to a transmission route for an Internet phone call mode;
transmitting an audio output signal, which is received by an external terminal connected to the external ordinary telephone, to the handset of the external ordinary telephone; and
transmitting an audio input signal, which is received by the external ordinary telephone, to an audio input terminal of the external terminal.

13. The method of claim 12, further comprising the step for making a phone call to a person to be called, using a station line telephone through a telephone network, when the connection route of the external ordinary telephone is set to a transmission route for a station line telephone call mode.

14. The method of claim 12, wherein the step for setting a call connection route comprises the steps of:
receiving dial key input signals from the external ordinary telephone;
making an Internet phone call to a person corresponding to a connection number by accessing an Internet telephone provider's server when the combination of the input dial keys indicates the connection number of the person to be called; and
making a phone call by establishing a direct call connection to the person to be called through an Internet service provider when the combination of the input dial keys indicates the IP address of the person to be called.

15. The method of claim 14, wherein in the step for receiving dial key input signals dial keys are input using number buttons of the telephone, or a keyboard, or a mouse.

16. The method of claim 12, if the combination of the input dial keys is a transmission route changing code for changing a call mode, further comprising the steps of:
switching the transmission route of the external ordinary telephone to an Internet phone call mode if the combination of the input dial keys is a transmission route changing code for changing a call mode and the currently set transmission route is a station line telephone mode; and
switching the transmission route of the external ordinary telephone to a station line telephone call mode if the currently set transmission route is an Internet phone call mode.

17. The method of claim 12, further comprising the step of checking multiple registration of a connection number after inputting information through a user interface for membership registration in the IP relay server.

18. The method of claim 12, further comprising the step of automatically connecting to the person to be called using a station line telephone number if an Internet phone call using an IP address cannot be made.

19. A method for an Internet telephone interface in a method for making an Internet phone call using an IP address, the method for an Internet telephone interface comprising the steps of:
making a database of the IP address of a plurality of terminals connected to the Internet; and
if a first terminal requests the IP address of a second terminal, the IP relay server providing the IP address of the second terminal to the first terminal after searching the database of the IP address for the IP address of the second terminal; or the IP relay server confirming the IP address of the second terminal by trying to access the second terminal using the IP address of the second terminal in the database, and if the IP address of the second terminal is a wrong number informing the first terminal that the IP address of the second terminal is a wrong number, and if the IP address of the second terminal is a correct number informing the first terminal of the IP address of the second terminal together with the fact that the IP address of the second terminal is a correct number, so that an Internet phone call directly using the IP address can be connected between the first terminal and the second terminal.

20. The method of claim 19, further comprising the step for trying to make a phone call using a free call site if a trial to make an Internet phone call using the IP address is failed.

21. The method of claim 19, further comprising the step for trying to make a phone call using a station line telephone line if both the trial to make an Internet phone call using the IP address and the trial to make a phone call using a free call site are failed.
